(19) United States
(12) Patent Application Publication
(10) Pub. No.: US 2010/0001090 A1
(43) Pub. Date: Jan. 7, 2010

(54) Liquid Particle Emitting Device

(76) Inventors: Arthur Hampton Neergaard, Cincinnati, OH (US); John Philip Hecht, West Chester, OH (US); James Robert Tinlin, Cincinnati, OH (US); Fernando Ray Tollens, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/492,600

(22) Filed: Jun. 26, 2009

Related U.S. Application Data
(60) Provisional application No. 61/077,877, filed on Jul. 3, 2008.

(51) Int. Cl. B05B 17/06

(52) U.S. Cl. 239/4; 239/102.2

(57) ABSTRACT

A liquid particle emitting device comprising a first reservoir formed of a perforated top plate comprising at least one aperture; and a base plate opposite said perforated top plate, wherein said perforated top plate and said base plate form the first reservoir comprising an inner volume. Within the inner volume of the first reservoir is at least one deflecting member.

### CROSS REFERENCE TO COPENDING APPLICATION

The present application claims priority to copending U.S. Ser. No. 61/077,877 to Neergaard, et al, filed Jul. 3, 2008, Applicant docket Number 11098P, the disclosure of which is hereby incorporated by reference.

### FIELD OF THE INVENTION

This invention relates generally to the field of devices for emitting liquid particles into the ambient air. More specifically, this invention relates to the use of liquid particle emitting devices which are suitable for generating particles of a liquid comprising one or more liquid active materials, such as fragrances, insecticides, and/or medications, and emitting them into the ambient air.

### BACKGROUND OF THE INVENTION

The use of devices to generate and distribute particles into the surrounding air is known. Conventional devices for generating particles typically include a liquid conductor, such as a wick or sponge, which draws the liquid from a reservoir to the vicinity of a particle generating member, such as an apertured plate. The apertured plate is vibrated during use, thereby causing particles of liquid to be formed in the aperture(s) of the plate and be emitted from the device. See e.g., U.S. Pat. Nos. 4,301,093 to Eck; 5,297,734 to Toda; 5,749,519 to Miller; 6,293,474 to Helf et al.; and 7,017,829 to Martens III et al.; and European Pat. Publ. No. 0 897 755 to Abe.

Many of these conventional devices provide liquid to the apertured plate by capillary action, where the liquid conductor is in contact with, or positioned to direct the liquid to, the inner face of the apertured plate. When actuated, the apertured plate deforms and vibrates, creating pressure on the liquid being supplied by the liquid conductor. A portion of the liquid is then forced into the aperture through the apertured plate and away from the device. These devices, however, are known to suffer from undesirable dampening effects when the apertured plate comes into contact with the liquid conductors. In some instances the dampening effects cause by the contact can be so excessive as to cause underperformance and undesirable wear and tear on the device. Recent attempts to address the dampening effects have focused on the introduction of compliant material for use in the liquid conductor. See, e.g., WO Publ. No. 2005/097349 to Burstall et al.

Other attempts to address the dampening effects include the introduction of a space for containing the liquid, such that the apertured plate does not come into direct contact with the liquid conductor. In these developments liquid is transported from a reservoir to the space via a fluidic channel which transports the liquid by way of capillary action in both vertical and/or lateral directions. The reservoir can be present below the space, above the space, and/or laterally disposed from the space. See, e.g., WO 2007/062698 to Hess et al.; see, also, U.S. Pat. Nos. 6,196,219 and 6,405,934 both to Hess et al.; and U.S. Patent No. 2005/0230495 to Feriani et al. For devices where the reservoir is positioned such that at least a portion of the liquid contained within the reservoir is above the space, the pressure on the liquid within the reservoir from gravity can cause undesirable leakage out of the apertures of the apertured plate which is located in a lower position. Without the use of additional liquid flow control technologies, such as pressure control valves, the liquid leakage can make the device unacceptable in terms of performance and cleanliness. For devices, where the reservoir is positioned below the space, the ability of the liquid conductor to draw the liquid from the reservoir and provide it into the space is typically limited by the vertical distance which the liquid conductor can raise the specific type of liquid contained within the reservoir. As a result, reservoirs which are typically shorter and wider are used to ensure that the liquid contained within the reservoir is within a certain vertical distance from the perforated top plate.

Despite the attempts to address the dampening effect problem encountered with conventional devices, there remains a need for a particle generating device which is less susceptible to dampening effects, yet is capable of sufficient performance and is capable of accommodating increased liquid lift without the use of pumps or liquid flow control members.

### SUMMARY OF THE INVENTION

One aspect of the present invention provides for a liquid particle emitting device comprising: a perforated top plate comprising at least one aperture; a base plate opposite said perforated top plate, wherein said perforated top plate and said base plate form a first reservoir comprising an inner volume; an electromechanical transducer operably connected to at least one of said perforated top plate and said base plate; and at least one deflecting member contained within said inner volume between said perforated top plate and base plate.

Another aspect of the present invention provides for a method for generating a particle comprising the steps of: providing a liquid particle emitting device comprising: a first reservoir comprising an inner volume, said first reservoir comprising: a perforated top plate comprising at least one aperture; a base plate opposite said perforated top plate; an electromechanical transducer operably connected to at least one of said perforated top plate and said base plate; and at least one deflecting member positioned within said inner volume between said perforated top plate and base plate, wherein said first reservoir is at least partially filled with a liquid; charging said electromechanical transducer to actuate said at least one of said perforated top plate and said base plate; and generating a particle by passing a portion of said liquid through said at least one aperture of said perforated top plate.

### BRIEF DESCRIPTION OF THE DRAWINGS

FIG. 1 is a top planar view of a liquid particle emitting device in accordance with at least one embodiment of the present invention.

FIG. 2 is a cross sectional view of the liquid particle emitting device shown in FIG. 1, taken along view line A-A of FIG. 1.

FIG. 3 is a simplified perspective view of a liquid particle emitting device in accordance with at least one embodiment of the present invention wherein the first reservoir is positioned above the reservoir but is offset from the reservoir by a lateral distance.

FIG. 4 is a simplified perspective view of another liquid particle emitting device in accordance with at least one embodiment of the present invention wherein the first reservoir is positioned directly above the reservoir.

FIG. 5 is a simplified perspective view of another liquid particle emitting device in accordance with at least one embodiment of the present invention wherein the first reservoir is oriented so that liquid particles will be emitted horizontally when the device is in an upright position.

FIG. 6 is a cross sectional view of a portion of the liquid particle emitting device of FIG. 3, taken along view line B-B of FIG. 3.

FIG. 7 is a cross sectional view of a portion of the liquid particle emitting in accordance with at least one embodiment of the present invention.

FIG. 8 is a cross sectional view of a portion of a liquid particle emitting device, wherein the deflecting member comprises a non-flat surface.

FIG. 9 is a cross sectional view of a portion of another liquid particle emitting device in accordance with at least one embodiment of the present invention, wherein the perforated top plate comprises a plurality of apertures.

FIG. 10 is a cross sectional view of a portion of another liquid particle emitting device in accordance with at least one embodiment of the present invention, wherein more than one deflecting member is provided in the inner volume.

### DETAILED DESCRIPTION OF THE INVENTION

### Definitions

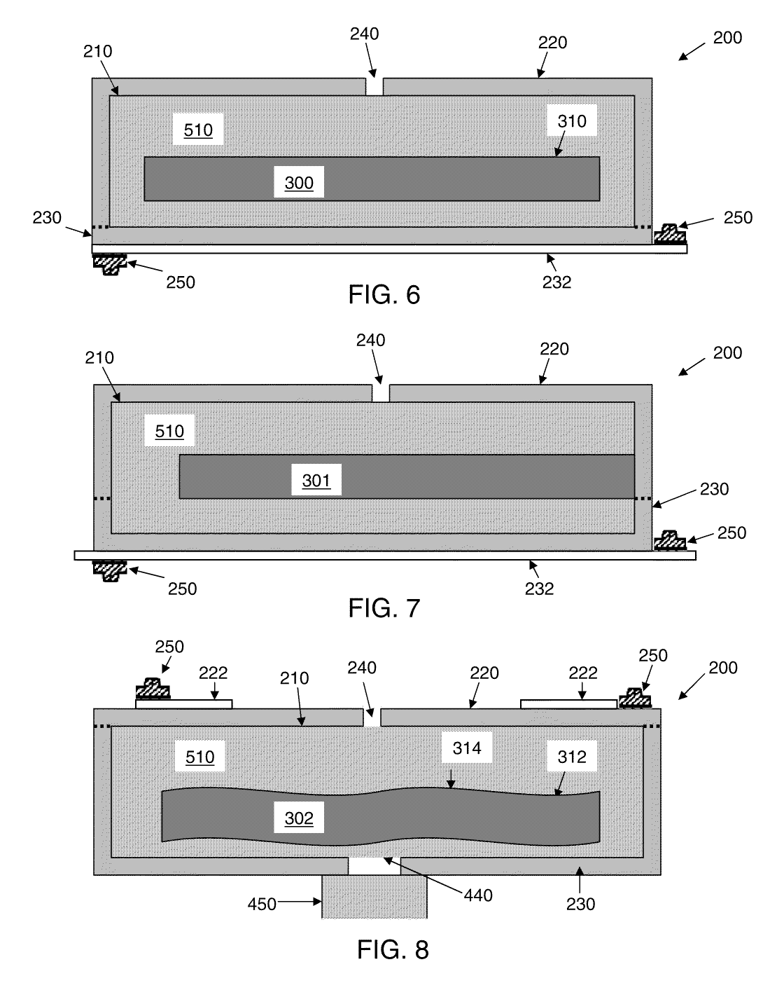

As used herein, a “decoupled configuration” means that the electromechanical transducer is operably connected to said base plate, thereby actuating the base plate during operation; whereas a “coupled configuration” means that the electromechanical transducer is operably connected to said perforated top plate, thereby actuating the perforated top plate during operation. FIG. 6 is an example of a decoupled configuration, whereas FIG. 8 is an example of a coupled configuration.

As used herein, “liquid communication” means that one structure is positioned such that a liquid can be transferred from that structure to another structure.

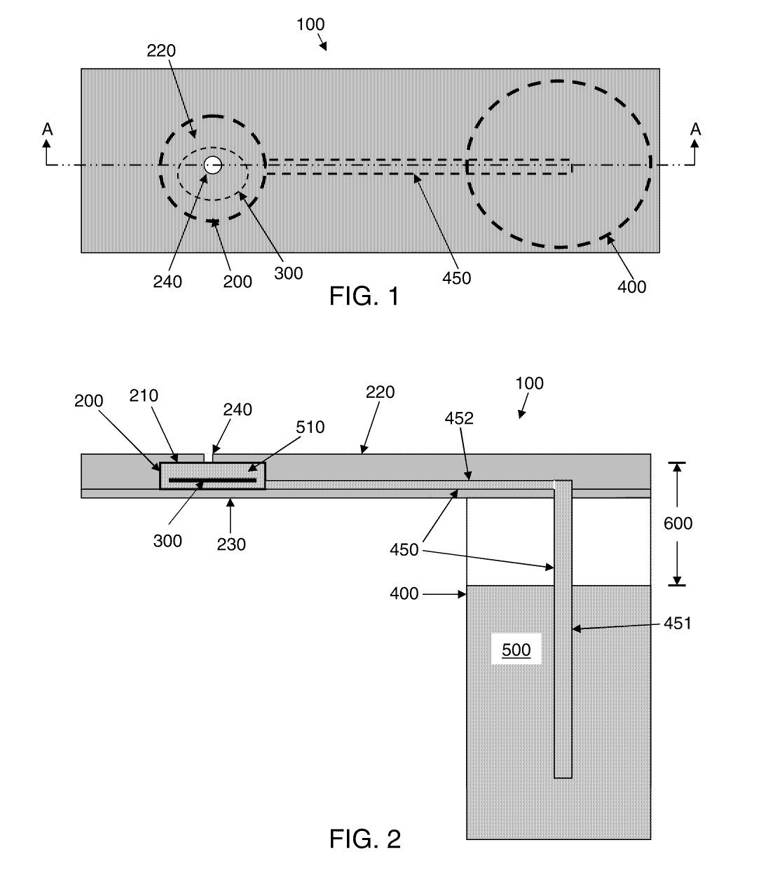

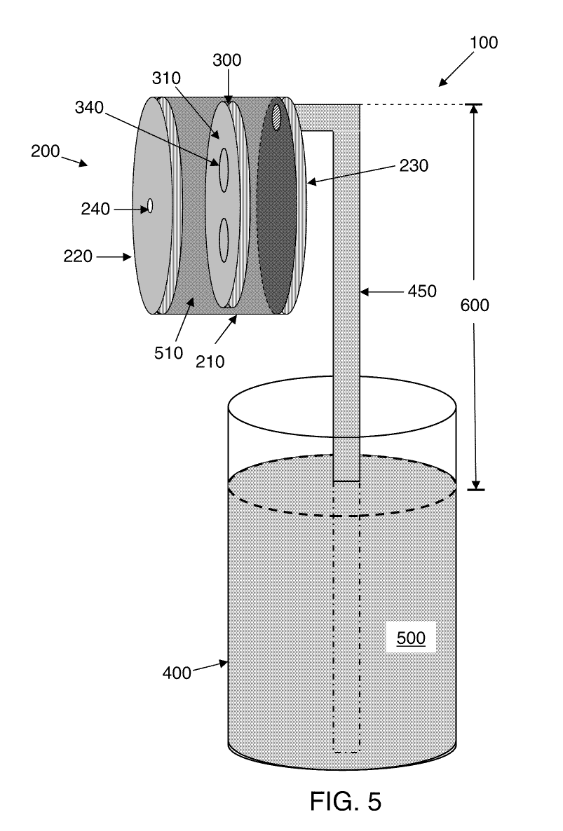

As used herein, “liquid lift height” means the vertical distance which the liquid must travel from 1) the highest level of the liquid within the second reservoir to 2) the highest point in the liquid passageway before entering or coming into contact with the portion of the inner face of the perforated top plate forming the lowest positioned aperture. In embodiments where the liquid passageway does not extend above the inner portion of the perforated top plate forming the lowest positioned aperture, the liquid lift height is measured as the vertical distance between the surface of the liquid contained within the second reservoir and the inner portion of the perforated top plate forming said apertures. See e.g. FIG. 1. Where the liquid passageway climbs above the perforated top plate forming the lowest positioned aperture, such as in FIG. 5, the liquid lift height is the vertical distance from the liquid surface in the second reservoir to the highest point in the liquid passageway.

As used herein “operably connected” means any form of connection between two or more elements which allows the elements to perform its desired function.

As used herein, the “planar cross sectional area” is the area of a slice through an object by a specified plane of reference. For example, a sphere having a radius of R would have a surface area of 4*Π*R² and a volume of 4/3*Π*R³. Using a plane of reference passing through the center of the sphere, the perimeter of said sphere is 2ΠR, and the planar cross sectional area of said sphere is Π*R². In the case of a cylinder having a radius of R, using a plane of reference orthogonal/perpendicular to the axis of that cylinder would yield a circular planar cross sectional area of Π*R². For that same cylinder, using a plane of reference parallel to the axis of that cylinder would yield a rectangular planar cross sectional area of 2*R*L, where L is the length of the cylinder.

As used herein, “vibrations” includes oscillations and other types of deformations.

It has been found that a liquid particle emitting device in accordance with at least one embodiment of the present invention provides a suitable device for emitting liquid particles in an efficient and cost effective way without unduly impacting the operation and performance of the device. Indeed, it is believed that the element of said at least one deflecting member can advantageously be introduced into any conventional liquid particle emitting device comprising a first reservoir for containing a volume of liquid. Importantly, these benefits have been achieved without the use of pumps or liquid flow control members.

Further, it has importantly been found that in addition to being less susceptible to dampening effects, the liquid particle emitting device of the present invention provides surprisingly improved liquid lift performance. It is believed that the introduction of at least one deflecting member into the inner volume of the first reservoir provides for important benefits such as increased lift performance where the second reservoir is positioned below the first reservoir. Further, although one of skill in the art would likely expect that the introduction of a foreign object, such as a deflecting member, into the first reservoir could impede or even decrease performance by absorbing any vibrational energy generated in the device and/or obstructing the flow of liquid to the perforated top plate, the present invention is capable of enhanced fluid lift performance without unduly impacting particle emitting performance.

FIG. 1 illustrates a liquid particle emitting device 100 comprising a first reservoir 200 which is laterally and vertically displaced from a second reservoir 400. This embodiment of the present invention comprises a perforated top plate 220 comprising at least one aperture 240. The first reservoir 200 is in liquid communication with the second reservoir 400 via liquid passageway 450. Contained within first reservoir 200 is a deflecting member 300. In this embodiment, the liquid passageway 450 includes a vertical segment 450 extending upwards away from the second reservoir, said vertical segment connecting to a lateral segment 452 extending towards the first reservoir. In one embodiment, the amount of liquid stored within said second reservoir is larger than the amount of liquid stored within the first reservoir such that during operation as liquid particles are emitted from the first reservoir, liquid contained with said second reservoir is transported across said liquid passageway to refill said first reservoir. FIG. 1 shows one embodiment where said liquid passageway 450 comprises a single liquid conductor. In one embodiment, the liquid passageway comprises a plurality of liquid conductors, for example 2 or more. The device further comprises an electromechanical transducer (not shown) operably connected to at least one of said perforated top plate and said base plate. Non-limiting examples of devices which can be improved by means of the addition of one or more deflecting members of the present invention include the devices disclosed in WO Publ. No. 2007/062698 to Hess et al.; Us Patent Appl. No. 2005/0230495 to Feriani et al.; U.S. Pat. Nos. 6,733,582 to Hess et al., 6,196,219 to Hess et al., and 6,405,934 to Hess et al., wherein said inner volume (referred to in the listed references as a space) further comprises at least one of said deflecting members.

FIG. 2 illustrates a liquid particle emitting device 100 wherein the view is taken along view line A-A of FIG. 1. As shown in this embodiment, the liquid particle emitting device comprises said perforated top plate 220; and a base plate 230 opposite said perforated top plate, wherein said perforated top plate and said base plate form a first reservoir 200 comprising an inner volume 210, and wherein said perforated top plate comprises at least one aperture 240. Said inner volume contains a volume of liquid 510 and at least one deflecting member 300. In this embodiment said perforated top plate forms the top and side walls of the inner volume, and said base plate forms the bottom wall of the inner volume. Those of skill in the art will understand that either the perforated top plate or the base plate can form the side walls of the inner volume. In another embodiment, the inner walls forming said first reservoir can be formed from a combination of portions of said perforated top plate portions of said base plate. The same first reservoir structure can be formed from a combination of portions of the perforated top plate and base plate. In one embodiment, the perforated top plate and the base plate are both portions of the same plate which can be folded onto itself.

In this embodiment, the second reservoir 400 is vertically and laterally displaced from the first reservoir 200. Further, said first reservoir 200 is in liquid communication with second reservoir 400 via a liquid passageway 450. Within said second reservoir 400 is a volume of liquid 500. Also shown in FIG. 2 is the liquid lift height 600. In this embodiment, since the liquid passageway does not extend above the level of said at least one aperture of said perforated top plate, the liquid lift height is the vertical distance which liquid must be transported from the surface level of the liquid 500 contained within said second reservoir 400 to portion of the perforated top plate 220 which forms the lowest positioned aperture.

In this embodiment, the perforated top plate 220 is shown having a flat top surface. In other embodiments, the perforated top plate can have one or more depressions, for example in the vicinity of the inner volume.

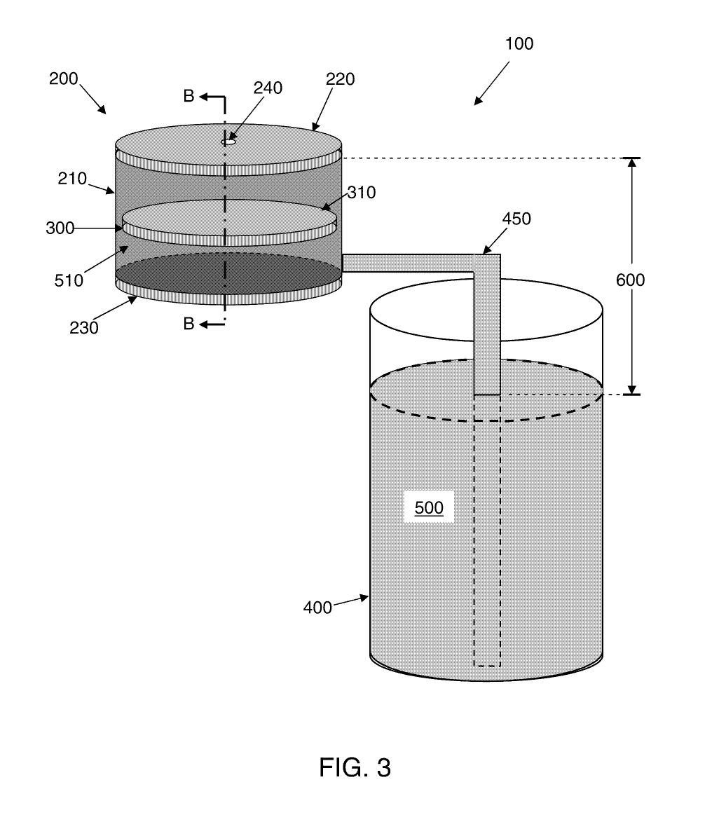

FIG. 3 illustrates a liquid particle emitting device 100, wherein the first reservoir 200 is positioned above the second reservoir 400 and offset from the reservoir by a lateral distance. Although, first reservoir 200 is shown having a cylindrical shape, those of skill in the art will understand that other shapes are within the scope of the invention, such as ovoidal, squared, rectangular or other geometric or irregular shapes. In this embodiment, a liquid passageway 450 enters the first reservoir at a lower portion of said first reservoir. In another embodiment, the liquid passageway enters the upper portion of the reservoir near the perforated top plate. The liquid passageway connects the first reservoir 200 to the second reservoir 400. The liquid passageway optionally contains a liquid conductor such as a wick, a sponge material, a hollow tune, such as a capillary tube, or a combination thereof, as disclosed herein below. The liquid passageway terminates as it comes into contact with the inner volume of the first reservoir. In one embodiment, the liquid conductor extends beyond the liquid passageway into the first reservoir. In another embodiment, the liquid conductor also terminates upon contact with the inner volume.

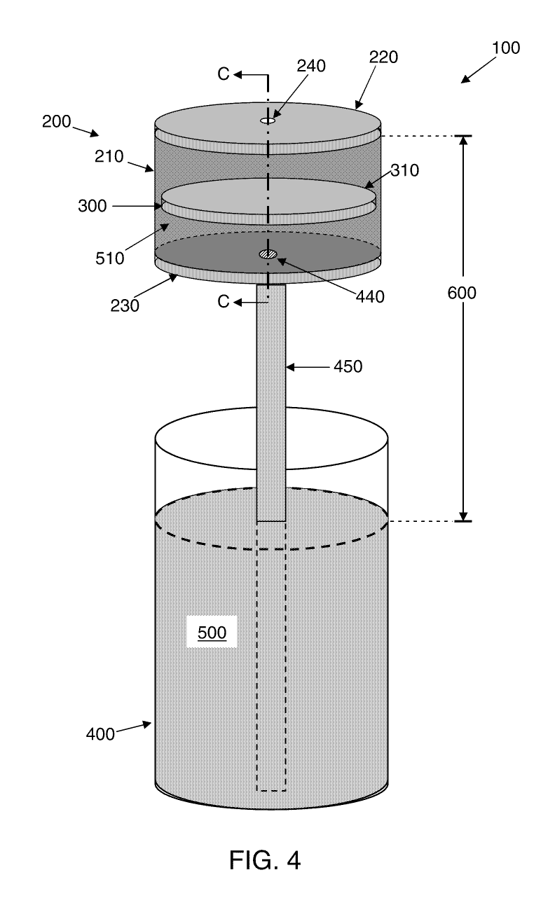

FIG. 4 illustrates a side elevational view of another liquid particle emitting device 100 in accordance with at least one embodiment of the present invention. The liquid particle emitting device exemplifies an embodiment wherein the first reservoir 200 is positioned directly above said second reservoir 400, such that any liquid transported from the second reservoir to the first reservoir does not need to travel a lateral distance. As such, in this embodiment, the liquid particle emitting device includes a liquid passageway 450 comprising a vertical distance but no lateral distance. Further, in this embodiment, the base plate 230 forms at least one aperture 440 wherein liquid delivered by said liquid passageway 450 enters the inner space 210 of the first reservoir 200. The liquid conductor is in liquid communication with the base plate such that liquid is directed through the aperture of the base plate and into the inner volume of the first reservoir. In one embodiment, the liquid conductor of the liquid passageway extends into and/or through said at least one aperture of said base plate. In another embodiment, the liquid conductor does not extend into and/or through said at least one aperture of said base plate.

FIG. 5 illustrates a side elevational view of another liquid particle emitting device 100 in accordance with at least one embodiment of the present invention wherein the first reservoir 200 is oriented so that liquid particles will be emitted horizontally when the liquid particle emitting device is in an upright position. In this embodiment, said at least one deflecting member 300 comprises one or more apertures 340. Here, the liquid lift height 600 is measured from the surface of the liquid 500 contained within said second reservoir 400, to the highest point in the liquid passageway before entering or coming into contact with the inner volume of the first reservoir 200.

FIG. 6 illustrates a cross sectional view of a portion of a first reservoir 200 of the liquid particle emitting device of FIG. 3, taken along view line B-B of FIG. 3. Within inner volume 210 is stored a volume of liquid 510 and at least one deflecting member 300. In one embodiment, more than one member is within the inner volume. The deflecting member 300 comprises a generally planar top surface 310. Further, in this embodiment, the liquid particle emitting device comprises a decoupled configuration, wherein an electromechanical transducer (not shown) is operably connected to the base plate 230, and the electromechanical transducer 232 is powered by a source of energy via electrodes 250. As such, in operation, electricity is passed from said electrodes actuate said base plate, resulting in deformation of the base plate and vibrations driving the liquid in the inner volume to contact the perforated top plate, creating particles as the liquid is driven through the apertures. The resultant particles are then projected by the vibrations of the base plate. In one embodiment, the base plate comprises a piezoelectric element. Like in FIG. 1, here, the perforated top plate 220 forms the top and side walls of the inner volume 210.

FIG. 7 illustrates a cross sectional view of a portion of a first reservoir 200, wherein said at least one deflecting member 301 is in a stationary position, wherein the deflecting member is attached to a portion of the side wall (here as formed from said perforated top plate 220). In another embodiment, the deflecting member is attached to a portion of the base plate 230. Without intending to be bound by theory, it is believed that despite said at least one deflecting member being in a stationary position, the device is still capable of allowing 1) liquid 510 can travel within the inner volume 210 and contact said at least one apertures 240 of said perforated top plate, and 2) at least one of said perforated top plate and said base plate to be actuated, causing particle formation and emission. Preferably, if said at least one deflecting member is attached to the perforated top plate and the base plate, the other plate is operably connected to the electromechanical transducer. In one embodiment, however, said at least one deflecting member is attached to the same plate as is operably connected to the electromechanical transducer. FIG. 7 further shows one embodiment, wherein the perforated top plate forms at least a portion of the side walls defining the first reservoir and at least a portion of the base plate forms at least a portion of the side walls defining the first reservoir.

FIG. 7 further shows an embodiment comprising an electromechanical transducer 232 in a decoupled configuration. In this embodiment said electromechanical transducer is a piezoelectric material. Electrodes 250 are operably connected such that when a voltage is placed across the piezoelectric material the piezoelectric material actuates, such as by vibrating. The vibrational energy generates a pressure upon the liquid within the first reservoir, resulting in the generation of a liquid particle and emitting of said liquid particle out of said aperture 240.

FIG. 8 illustrates a cross sectional view of a portion of a first reservoir 200, the liquid particle emitting device of FIG. 4, taken along view line C-C of FIG. 4, wherein the deflecting member 302 comprises an at least partially non-flat surface. In this embodiment, said at least partially non-flat surface comprises a convex upward portion 314 and a concave downward portion 312. A textured surface can also be provided. The textured surface can have macroscopic deformation, such as channels or recesses or grooves, or microscopic deformations such as channels, recesses, or grooves. In one embodiment, the macroscopic deformation comprises an upward or downward bent rim, such as created when a shape is punched out in a die/punch from a larger sheet of material. Those of skill will understand that any macroscopic deformation which causes the deflecting plate to create a visible gap when laid on a flat surface is considered a macroscopic deformation. In one embodiment, the microscopic deformation comprises any deformations which when viewed with the human eye from a distance of 18 inches are not individually noticeable and rather create a surface roughness such as an acid etching or deformation having a depth and/or minor dimension from about 0.01 mm to about 0.5 mm. Additional deformations which provide said deflecting member with a textured surface are also within the scope of the invention.

One of the benefits obtained by providing an at least partially non-flat surface is that if the deflecting member were to be flush with the perforated top plate or the bottom plate having an aperture, the deflecting member is less likely to form a continuous seal obstructing passage of liquid through the aperture. In the device shown in FIG. 8, the liquid passageway 450 provides liquid into the inner volume 210 via the one or more apertures formed in the base plate 230, any partially non-flat surfaces provided in the lower facing side of the at least one deflecting member 302 would allow for passage of liquid into the inner volume.

FIG. 8 further exemplifies an embodiment where the perforated top plate 220 is in a coupled configuration, wherein the perforated top plate comprises an electromechanical transducer 222 which is powered by an energy source via electrodes 250. The electromechanical transducer of this embodiment is a flat ring shaped plate which can resemble a flat washer. Suitable electromechanical transducer materials are disclosed below, such as a piezoelectric material. One example of an electronic circuitry system suitable for use with the present invention is provided in U.S. Pat. No. 6,196,219 to Hess et al., at FIG. 5. Those of ordinary skill in the art will understand that the electromechanical transducer can be powered with a variety of ways, including but not limited to by being plugged into a wall socket, powered by a battery, or solar powered. One example of a suitable coupled configuration for the perforated top plate and the electromechanical transducer is provided in U.S. Pat. No. 6,341,732 to Martin et al., at col. 4, lines 55-67. As shown herein, the perforated top plate and the base plates are shown as single layered walls. Those of skill will understand that these plates can comprise multiple layers, wherein one of the layers can be the electromechanical transducer. The electromechanical transducer is operably connected to the electrodes 250 and can deform and vibrate, creating liquid particles in the perforated top plate. As defined herein, the electromechanical transducer can be provided as a portion of the perforated top plate or the base plate, or can be a separate layer operably connected to one or both of these plates. In this embodiment, an electromechanical transducer is operably connected to the perforated top plate and said electrodes. This would be a coupled configuration. Further, more than one electromechanical transducers can be used on one or more of the plates without deviating from the present invention.

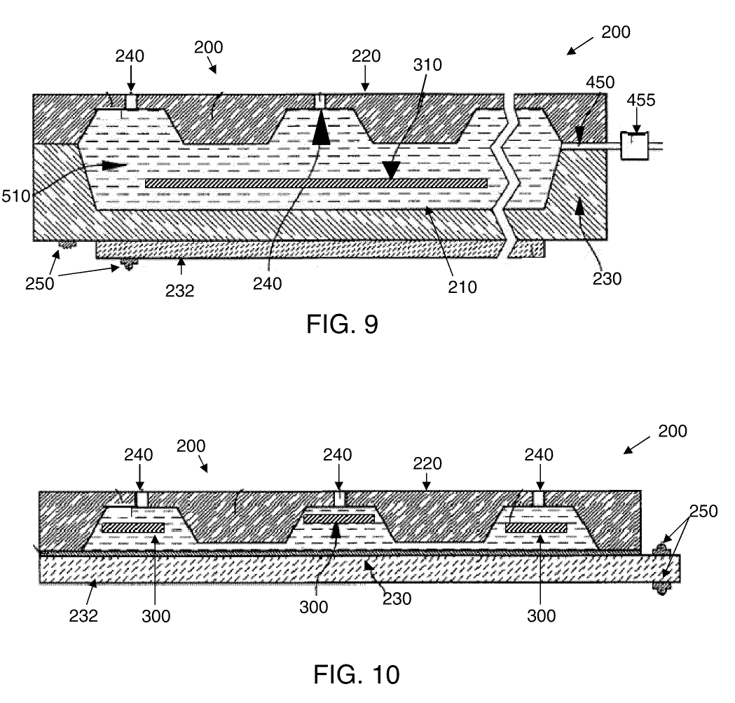

FIG. 9 illustrates a cross sectional view of another first reservoir 200 of a liquid particle emitting device, wherein the perforated top plate 220 comprises a plurality of apertures 240. In this embodiment, the inner volume 210 comprises a tapered flowpath leading to the apertures. In this embodiment, said at least one deflecting member 310 resides within the inner volume 210 which is filled or at least partially filed with liquid 510 such that liquid can contact said one or more apertures formed in the perforated top plate. Further, in this embodiment, the liquid passageway 450 further comprises a check valve 455. Any mechanism capable of controlling the flow of liquid into and out of the first reservoir is suitable for use herein as the check valve. Furthermore, base plate 230 is operably connected to an electromechanical transducer 232. Non-limiting examples of suitable devices which can be used as first reservoirs in accordance with one or more embodiments of the present invention are provided in U.S. Pat. Nos. 6,196,219 and 6,405,934, both to Hess et al.

FIG. 10 illustrates a cross sectional view of a first reservoir 200 of another liquid particle emitting device, wherein the first reservoir 200 contains more than one deflecting member 300, such as three deflecting members. In this embodiment, each of the three deflecting members is provided within a separate flowpath. In this embodiment, the flowpaths are tapered such that the upper portion of the flowpath, oriented towards the aperture, has a smaller cross sectional area compared to the portion of the flowpath facing the remainder of the inner volume. Those of skill in the art will understand that one or more of the flowpaths can be free of a deflecting member; alternatively, one or more of the flowpaths can contain more than one deflecting member. In this embodiment, the electromechanical transducer 232 is positioned below said base plate 230.

### 1. DEFLECTING MEMBER

The first reservoir of the present invention comprises at least one deflecting member, alternatively more than one deflecting member, such as two or three deflecting members. The deflecting member of the present invention can be stationary or non-stationary within the inner volume of the first reservoir. A non-limiting example of a stationary deflecting member is provided in FIG. 7. Non-limiting examples of non-stationary deflecting members are provided in FIGS. 6 and 8.

In one embodiment, where the deflecting member is non-stationary, it is desirable for any direct contact between the deflecting member and the plate (perforated top plate and/or base plate) which is operably connected to the electromechanical transducer to be minimized such that the actuation of the electromechanical transducer is not impeded. Although it is desired that the actuation of the electromechanical transducer is not unduly impeded, it does not mean that said at least one deflecting member must not come into contact with the perforated top plate and/or the base plate. One way to control whether the deflecting member floats or sinks within the inner volume of the first reservoir is to select a deflecting plate material such that the density of the material is higher or lower than the density of the liquid, depending on whether float or sink is desired. In one embodiment, the deflecting member comprises a density of from about 0.5 g/cm³ to about 10 g/cm³, alternatively from about 0.8 g/cm³ to about 8 g/cm³, alternatively from about 0.9 g/cm³ to about 5 g/cm³, alternatively from about 1 g/cm³ to about 2 g/cm³. In one embodiment, where it is desirable for the deflecting plate to remain near the upper portion of the inner volume, the deflecting member comprises a density within a certain range of the density of the liquid, for example wherein the density of the deflecting member is within from about 0.01 g/cm³ to about 0.1 g/cm³, alternatively from about 0.05 g/cm³ to about 0.08 g/cm³ to the density of the liquid. The deflecting member can also be selected to be denser than the liquid within the first reservoir by the same density range as mentioned immediately above. All measurements defined herein (i.e. density and modulus of elasticity) are obtained at 22° C.

Other ways to decrease any impact the deflecting member may have on the actuation of the electromechanical transducer and/or the flow of liquid to and/or through the apertures formed in either the perforated top plate or the base plate include: 1) providing a partially non-flat surface on at least a portion of the deflecting member's outer surface as explained above; 2) providing one or more apertures within the deflecting plate which can generally vertically when the plate is in a horizontal position; 3) by providing a deflecting member which does not have a planar cross sectional area large enough to obscure all of the apertures on either of the perforated top plate or the base plate at the same time, and a combination thereof.

In one embodiment, the deflecting member comprises a material which is flexible, meaning it vibrates and/or deforms during operation when the electromechanical transducer is actuated. In another embodiment, the deflecting member is substantially non-flexible, meaning that it does not vibrate and/or deform during operation. One way to measure the flexibility of the deflecting member is by a measure of the modulus of elasticity. Additionally, suitable deflecting members include foam and solid forms.

In one embodiment, the deflecting member is a flexible deflecting member, comprising a modulus of elasticity of from about 1 kN/mm² to about 30 kN/mm², alternatively from about 5 kN/mm² to about 25 kN/mm². Non-limiting examples of suitable materials which can be used to make a flexible deflecting member include thermoplastic polymeric materials such as: thermoplastic elastomer; thermoplastic vulcanizate; thermoplastic polyurethane; ethyl-vinyl acetate copolymer resins; polyethylene, polypropylene, ethyl vinyl acetate, polyethersulfone, polyvinylidene fluoride, polytetrafluroethylene, polyethersulfone, and mixtures thereof or combinations thereof. For example, a deflecting member having multiple layers can have a combination of separate discrete layers of varying thermoplastic polymeric materials.

In another embodiment, the deflecting member is substantially non-flexible, comprising a modulus of elasticity of from about 30 kN/mm² to about 400 kN/mm², alternatively from about 45 kN/mm² to about 250 kN/mm², alternatively from about 69 kN/mm² to about 210 kN/mm², alternatively from about 105 kN/mm² to about 200 kN/mm². Non-limiting examples of suitable materials for use in the substantially non-flexible deflecting member include: a metal material comprising at least one of: a stainless steel material; a magnesium material; an aluminum material; a brass material; a titanium material; a copper material; a beryllium material; and a mixture thereof or combination thereof.

Without intending to be bound by theory, it is believed that the deflecting member deflects some amount of vibrational energy created within the inner volume of the first reservoir when the present device is in operation. Although it is possible that the deflecting member deflects some amount of vibrational energy, it is not required that the deflecting member deflect any measurable amount of vibrational energy. As such, although the deflecting member is called a “deflecting member” the deflecting member need not actually create any measurable deflections of vibrational energy during operation. In one embodiment, the deflecting member comprises a metal material, a thermoplastic polymeric material, or a mixture or combination thereof.

In one embodiment, the deflecting member has a planar cross sectional area, measured at a plane of reference perpendicular to the plane of the electromechanical transducer, of from about 20 mm² to about 100 mm², alternatively from about 40 mm² to about 80 mm², alternatively from about 60 mm² to about 70 mm². In one embodiment, the planar cross sectional area of the deflecting member is from about 25% to about 99% of the planar cross sectional area of the inner volume, as measured at its largest planar dimension at a plane of reference perpendicular to the plane of the electromechanical transducer, alternatively from about 60% to about 99%.

In one embodiment, when using a plane of reference parallel to the plane of the electromechanical transducer, the deflecting member comprises a thickness of about 0.01 mm to about 1 mm, alternatively from about 0.02 mm to about 0.075 mm, alternatively from about 0.05 mm to about 0.06 mm. In another embodiment, the deflecting member comprises an exterior shell volume of from about 0.2 mm³ to about 100 mm³, alternatively from about 5 mm³ to about 7 mm³. As defined herein, the exterior shell volume is the volume of the object assuming it was solid and non-porous or hollow.

### 2. PERFORATED TOP PLATE AND BASE PLATE

The perforated top plate of the present invention comprises at least one layer, and forms at least one aperture through the thickness of the plate. Said at least one aperture forms a particle flowpath connecting the inner volume of the first reservoir to the exterior ambient environment. In one embodiment, the inner volume forms one or more liquid flowpaths which direct liquid to said one or more apertures.

In another embodiment, the perforated top plate comprises a plurality of apertures. Where the perforated top plate comprises a plurality of apertures, the plurality of apertures can be arranged in any pattern which allows for the generation and projection of particles such as a random pattern, a uniform pattern, such as a hexagonal lattice, or a combination thereof. In one embodiment, the perforated top plate comprises a plurality of apertures, for example from 2 to 676 apertures, from 3 to 169 apertures, or from 4 to 84, 5 to 21 apertures. In one embodiment the aperture(s) are positioned randomly, in another embodiment the aperture(s) are positioned to form a shape such as an arrow, a circle, a square, a triangle, a diamond, an alpha-numeric character, a flower, or any other suitable shape which can be consumer desirable. Non-limiting examples of suitable perforated top plates include those disclosed in U.S. Pat. Nos. 4,533,082; 4,605,167; 4,530,464; 4,632,311; 6,293,474; and U.S. Ser. No. 11/273,461, filed Nov. 14, 2005.

The apertures formed in the perforated top plate, optionally in the base plate, and/or deflecting member, hereinafter “the apertures”, can have the same shapes/dimensions or different shapes/dimensions. In one embodiment, one or more of the apertures comprise a cross sectional area from about 25 microns² to about 8000 microns², alternatively from about 100 microns² to about 6000 microns², alternatively from about 500 microns² to about 3000 microns². In another embodiment, one or more of the apertures can be in any shape suitable to generate a particle including cylinders, squares, rectangles, pyramid, and cones.

In one embodiment, one or more of the apertures comprises a conical shape the cone shaped aperture can be oriented with the smaller cross section facing the liquid conductor or away from the liquid conductor. Non-limiting examples of perforated top plates comprising conical shaped apertures include U.S. Pat. Nos. 5,152,456 and 5,261,601; and WO Publ. No. 94/09912.

Non-limiting examples of suitable materials for use as either the perforated top plate and the base plate include: electroplated nickel cobalt; nickel, electro-formed nickel, magnesium-zirconium alloy, stainless steel, other metals, other metal alloys, composites, etched silicon, plastics, and mixtures or combinations thereof. Further, the perforated top plate comprises a frontal face and a rear face, wherein the frontal face is oriented to project particles away from the device and the rear face is oriented to face the liquid as supplied by the liquid source via the liquid conductor.

In one embodiment, the base plate is formed from the same material as the perforated top plate. As disclosed herein, in one embodiment, the base plate comprises one or more apertures to allow liquid to be delivered into the inner volume of the first reservoir. Any apertures formed in the base plate can have the same dimensions as the apertures formed in the perforated top plate.

In one embodiment the base plate comprises an actuating member formed in a discrete area of said base plate or the perforated top plate, such that when the actuating member undergoes deformation and/or vibration, the actuation is at least partially transferred to the liquid stored within the inner space of the first reservoir. This energy transferred into the inner space is believed to cause the liquid to enter said one or more apertures formed within the perforated top plate, forming a liquid particle. The liquid particle is then emitted from the device.

### 3. ELECTROMECHANICAL TRANSDUCER

The present liquid particle emitting device comprises an electromechanical transducer operably connected to the perforated top plate. Electromechanical transducers according to the present invention can be made of any material capable of converting electrical energy to mechanical energy. Examples of a suitable materials for use as an electromechanical materials include but are not limited to piezoelectric materials and piezoelectric ceramic materials. The use of electromechanical transducers comprising piezoelectric materials for generating particles is known in the art. Accordingly, the electromechanical transducer will not be described in detail except to say that when alternating voltages are applied to the opposite upper and lower sides of the electromechanical transducer, these voltages produce electrical fields which cause the electromechanical transducer to expand or contract in radial directions. This expansion or contraction is communicated to the perforated top plate causing it to vibrate such that a pressure is exerted upon the liquid supplied by the liquid conductor. As such, particles are generated when liquid is forced into and through the aperture(s) of the perforated top plate.

As explained herein, the electromechanical transducer is operably connected to at least one of said perforated top plate and/or said base plate as long as during operation, when the electromechanical transducer is actuated it causes a pressure within the liquid contained in the first reservoir. The resultant pressure on the liquid causes a portion of the liquid to enter said aperture of said perforated top plate, creating a particle and emitting said particle out of said inner volume away from the device. Thus, in one embodiment the device comprises an electromechanical transducer in a coupled configuration. In another embodiment, the device comprises an electromechanical transducer in a decoupled configuration. Non-limiting examples of suitable electromechanical transducers include those disclosed in U.S. Pat. No. 4,533,082; U.S. Pat. No. 4,605,167; U.S. Pat. No. 4,530,464 U.S. Pat. No. 4,632,311, U.S. Pat. No. 7,017,829 and U.S. Ser. No. 11/273,461, filed Nov. 14, 2005.

### 4. LIQUID PASSAGEWAY

The liquid passageway allows for liquid to travel from the second reservoir to the first reservoir. In one embodiment, the liquid passageway comprises a liquid conductor which provides sufficient capillary action to draw liquid from the second reservoir and deliver it to the first reservoir. Examples of suitable liquid conductors are known and include sponge type materials, wicks, hollow solid channels such as capillaries tubes and channels, and combinations thereof. Non-limiting examples of liquid conductor materials are provided in: WO Publication No. 2005/097349 and U.S. Pat. Nos. 6,341,732 and 7,017,829 both to Martens III et al.; U.S. Patent App. Ser. No. 60/937,134 to Tollens et al.; and EU Pat. Publ. No. 0 897 755 to Abe.

In one embodiment, the liquid passageway comprises a vertical portion and/or a lateral portion. Examples of vertical and lateral liquid passageways are provided herein and WO Publ. No. 2007/062698, U.S. Pat. Nos. 6,196,219 and 6,405,934 all to Hess et al. Although it is suitable to use a vertical liquid passageway, where liquid is drawn from a second larger reservoir which would typically be positioned below the first reservoir, it is possible for the second reservoir to be positioned above the first reservoir. See, e.g., WO 2007/062698, compare FIG. 1b with FIG. 1c. One consideration when providing a second reservoir positioned above the first reservoir is that gravity can cause liquid to be pushed into the first reservoir to the point that liquid may leak out of the apertures formed in the perforated top plate. To control undesirable leakage, a check valve can be introduced in the liquid passageway before the liquid enters the inner volume of the first reservoir. Any obstruction or valve capable of controlling the amount of flow is suitable for use herein. In one embodiment, the liquid passageway is free of an obstruction such as a check valve or an active transport member such as a pump. Importantly, the present invention is capable of achieving increased liquid lift height without the use of an active transport member to facilitate the movement of liquid from the second reservoir into the first reservoir. Importantly, the present invention is capable of using capillary action to transfer the liquid across the liquid passageway. It has been unexpectedly found that when a deflecting member is provided in the first reservoir improvements to the liquid lift height were achieved.

### 5. LIQUID

The device of the present invention is capable of generating particles from a liquid comprising at least one liquid active material. In one embodiment, the liquid is in the form of a fluid comprising a liquid component and an optional non-liquid component such as a particulate within the liquid. Although the present device has been found to provide liquid particle emitting performance, the liquid can also escape the device in the form of vapors. In one embodiment, the liquid comprises two or more liquid active materials.

Liquid active materials suitable for use with the present invention comprise perfumes, air fresheners, deodorizers, odor eliminators, malodor counteractants, household cleaners, disinfectants, sanitizers, repellants, insecticide formulations, mood enhancers, aroma therapy formulations, therapeutic liquids, medicinal substances, or mixtures thereof. Non-limiting examples of suitable liquid active materials are disclosed in U.S. Ser. No. 11/273,461.

### 6. REFILL

In refill delivery systems applications, it is be desirable to separate the unit into two or more parts. One embodiment of the present invention provides for a refill system comprising the second reservoir, the liquid passageway (or a portion thereof) and a refill volume of liquid. In another embodiment, the refill system comprises all elements of the device other than the first reservoir. In another embodiment of the invention the refill system comprises the second reservoir, a refill volume of liquid, the liquid passageway, and the first reservoir. The reusable components may then comprise a device housing, the drive electronics and a power source. Suitable refilling systems for use herein are described in detail in U.S. Patent Publ. No. 2005/0230495 to Feriani et al.

### 7. METHOD OF USE

One method for generating a particle in accordance with the present invention comprises the steps of: providing a liquid particle emitting device comprising: a first reservoir comprising an inner volume, said first reservoir comprising: a perforated top plate comprising at least one aperture; a base plate opposite said perforated top plate; an electromechanical transducer operably connected to at least one of said perforated top plate and said base plate; and at least one at least one deflecting member positioned within said inner volume between said perforated top plate and base plate, wherein said first reservoir is at least partially filled with a liquid, such that at least a portion of the liquid is in contact with the aperture of the perforated top plate; charging said electromechanical transducer to actuate said at least one of said perforated top plate and said base plate; and generating a particle by passing a portion said liquid through said at least one aperture of said perforated top plate.

The device in operation can be driven in many different modes including a continuous sine wave mode, other continuous modes, a single pulse mode, trains of pulses, single synthesized waveforms, trains of synthesized waveforms, bimodal modes, or other modes known in the art. Modes of operating atomizing devices are well known and are disclosed in U.S. Ser. No. 11/273,461, filed Nov. 14, 2005, and WO 2007/062698.

### 8. LIQUID LIFT HEIGHT TEST METHOD

Liquid lift height is determined in accordance with the following method: 1) place a sample device in a stand having dimensions of 20″×⅜″ with a triangular support having 4″ legs, secure said sample device to said stand using a clamp; 2) place a sheet of black construction paper behind the stand above the aperture in the perforated top plate; 3) place a metric ruler directly below the highest point in the liquid passageway (below the lowest portion of the perforated top plate forming the lowest positioned aperture or the highest point in the liquid passageway if above the prior position); 4) operate the sample device and record whether any visible spray is collected on the black construction paper; 5) continue operating until no appreciable amount of spray is recorded. The liquid lift height is measured at the moment when no appreciable amount of spray occurs, as the vertical distance on the metric ruler from the lowest point in the meniscus of the liquid within the second reservoir. This test is performed three consecutive times at the same power level to determine the liquid lift height.

### 9. WORKING EXAMPLES

### Example I

A liquid particle emitting device in accordance with the present invention: wherein the first reservoir has a cylindrical shape with an inner volume diameter of 10 mm and height of 130 microns, which is positioned above the second reservoir; second reservoir containing 30 ml of a liquid containing a perfume. Said second reservoir is offset from the first reservoir by a lateral distance of 10 mm. as measured as the closest lateral distance between the two reservoirs. Various liquid conductors composed of polyethylene materials supplied from MicroPore Plastic Inc. of Georgia, USA are used to form the liquid passageway between the second reservoir and the lateral channel. Although all liquid conductors have the same overall dimensions, it is believed that the ability of the conductor to lift fluid is not dependant upon the overall dimensions. The lateral channel is hollow.

Table 1 shows liquid lift height as a function of the type of liquid conductor and the presence of a deflecting member within the first reservoir. The deflecting member used herewith is a circular plate made of stainless steel with diameter of 9.5 mm and thickness 50 micron.

TABLE I

| | | | | | Liquid |
|---|---|---|---|---|---|
| | | | | | Lift |
| | | Pore Size | Pore Vol. | Deflecting | Height |
| Sample | Liquid Conductor | (microns²) | (microns³) | Member? | (mm) |
| 1 | Liquid | 32 | 32 | None | 25 |
| | Conductor A | | | | |
| 2 | Liquid | 27 | 61 | None | 21 |
| | Conductor B | | | | |
| 3 | Liquid | 69 | 72 | None | 23 |
| | Conductor C | | | | |
| 4 | Liquid | 32 | 32 | Yes | 55 |
| | Conductor A | | | | |
| 5 | Liquid | 27 | 61 | Yes | 53 |
| | Conductor B | | | | |

Table I demonstrates that the addition of the deflecting member according to the present invention significantly increases the liquid lift height of a fluid liquid conductor system, independently of its pore size or pore volume. Test samples 4 and 5 are in accordance with the present invention.

### Example II

A liquid particle emitting device similar to the one used in Example I with Liquid Conductor A is tested, wherein the height of the inner volume chamber is varied from 130 microns to 15 microns are used to determine the effect on the volume of the first reservoir on liquid lift height.

TABLE II

| | First Reservoir | Deflecting | Liquid Lift |
|---|---|---|---|
| Test Sample | Height (mm) | Member? | Height (mm) |
| 1 | 130 | None | 23 |
| 2 | 105 | None | 25 |
| 3 | 81 | None | 27 |
| 4 | 68 | None | 29 |
| 5 | 38 | None | 31 |
| 6 | 15 | None | 35 |
| 7 | 130 | Yes | 55 |

Table II demonstrates that the addition of the deflecting member provides a greater benefit with respect to liquid lift height than the effect of reducing the volume of the first reservoir.

### Example III

A liquid particle emitting device, in accordance with at least one embodiment of the present invention, is provided, wherein the first reservoir is positioned directly above the second reservoir and the electromechanical transducer is connected to the perforated top plate. The first reservoir is cylindrical in shape having an inner volume diameter of 17 mm and height of 3 mm. A capillary tube is used as a liquid conductor between the second reservoir and the outside wall of the base plate of the first reservoir. A flexible deflecting member made of polyester polyurethane with a density of approximately 55 kg/m³, with cylindrical shape having a diameter of 5 mm and a thickness of 1 mm is placed inside the first reservoir. Table 3 demonstrates the effect of varying the diameter of the capillary tube and the presence of a flexible deflecting member on liquid lift height.

TABLE III

| | Capillary Tube | Deflecting | Liquid Lift |
|---|---|---|---|
| Test Sample | Diameter (μm) | Member? | Height (mm) |
| 1 | 500 | no | 0 (no emission) |
| 2 | 1000 | no | 0 (no emission) |
| 3 | 250 | yes | 50 |
| 4 | 500 | yes | 25 |
| 5 | 1000 | yes | 10 |

Table III demonstrates the surprising performance benefits obtained by a liquid particle emitting device of the present invention. Test samples 1 and 2, without a deflecting member are not capable of emitting a particle; whereas Test samples 3, 4, and 5, with varying capillary tube diameters provide liquid lift heights at diameters as low as 250 μm.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the DETAILED DESCRIPTION OF THE INVENTION are, in the relevant part, incorporated herein by reference; the citation of any document is not to be construed as an admission that it is prior art with respect to the present invention. To the extent that any meaning or definition of a term or in this written document conflicts with any meaning or definition in a document incorporated by reference, the meaning or definition assigned to the term in this written document shall govern.

Except as otherwise noted, the articles “a,” “an,” and “the” mean “one or more.”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid particle emitting device comprising:
a. a perforated top plate comprising at least one aperture;
b. a base plate opposite said perforated top plate, wherein said perforated top plate and said base plate form a first reservoir comprising an inner volume;
c. an electromechanical transducer operably connected to at least one of said perforated top plate and said base plate; and
d. at least one deflecting member contained within said inner volume between said perforated top plate and base plate.

2. The liquid particle emitting device of claim 1, wherein said at least one deflecting member is non-stationary within said inner volume.

3. The liquid particle emitting device of claim 1, wherein said at least one deflecting member comprises at least one aperture.

4. The liquid particle emitting device of claim 1, wherein said deflecting member comprises an at least partially non-flat surface.

5. The liquid particle emitting device of claim 1, wherein said deflecting member comprises a planar face oriented towards said perforated top plate, wherein at least a portion of said planar face comprises a textured surface.

6. The liquid particle emitting device of claim 1, wherein said at least one deflecting member has a density of from about 0.5 g/cm³ to about 10 g/cm³.

7. The liquid particle emitting device of claim 1, wherein said at least one deflecting member has a modulus of elasticity of from about 30 kN/mm² to about 400 kN/mm².

8. The liquid particle emitting device of claim 7, wherein said at least one deflecting member comprises a metal material.

9. The liquid particle emitting device of claim 1, wherein said at least one deflecting member has a modulus of elasticity of from about 1 kN/mm² to about 30 kN/mm².

10. The liquid particle emitting device of claim 9, wherein said at least one deflecting member comprises a thermoplastic polymeric material.

11. The liquid particle emitting device of claim 1, wherein said at least one deflecting member has a planar cross sectional area of from about 20 mm² to about 100 mm².

12. The liquid particle emitting device of claim 11, wherein the planar cross sectional area of said at least one deflecting member is from about 50% to about 80% of the planar cross sectional area of the inner volume.

13. The liquid particle emitting device of claim 11, wherein said at least one deflecting member has a thickness of from about 0.05 mm to about 1 mm.

14. The liquid particle emitting device of claim 1, wherein said inner volume contains a liquid comprising at least one liquid active material.

15. The liquid particle emitting device of claim 14, wherein said at least one deflecting member has a density which is within about 0.01 g/cm³ to about 0.1 g/cm³ the density of the liquid.

16. The liquid particle emitting device of claim 15, wherein said at least one deflecting member has a density which is equal to or greater than the density of the liquid.

17. The liquid particle emitting device of claim 16, wherein said electromechanical transducer comprises a piezo electric transducer, wherein said piezo electric transducer is operably connected to said base plate, wherein said at least one deflecting member has a planar cross sectional area of from about 20 mm² to about 100 mm², wherein said at least one deflecting member comprises a thickness of from about 0.05 mm to about 1 mm, and wherein said at least one deflecting member has a modulus of elasticity from about 30 kN/mm² to about 400 kN/mm².

18. The liquid particle emitting device of claim 1, further comprising a second reservoir in liquid communication with said first reservoir via a liquid passageway.

19. The liquid particle emitting device of claim 18, wherein said liquid passageway comprises a lateral segment.

20. A method for generating a liquid particle comprising the steps of:
a. providing a liquid particle emitting device comprising:
i. a first reservoir comprising an inner volume, said first reservoir comprising:
1. a perforated top plate comprising at least one aperture;
2. a base plate opposite said perforated top plate;
ii. an electromechanical transducer operably connected to at least one of said perforated top plate and said base plate; and
iii. at least one at least one deflecting member positioned within said inner volume between said perforated top plate and base plate, wherein said first reservoir is at least partially filled with a liquid;
b. charging said electromechanical transducer to actuate said at least one of said perforated top plate and said base plate; and
c. generating a particle by passing a portion of said liquid through said at least one aperture of said perforated top plate.
